(19) United States
(12) Patent Application Publication
(10) Pub. No.: US 2011/0052203 A1
(43) Pub. Date: Mar. 3, 2011

(54) CONTROL UNIT HAVING A DEVICE FOR OPTICAL DATA TRANSMISSION

(75) Inventors: Tobias Stumpf, Winnenden (DE); Klaus Schwarze, Duderstadt (DE)

(73) Assignee: ROBERT BOSCH GMBH, Stuttgart (DE)

(21) Appl. No.: 12/735,967

(22) PCT Filed: Feb. 25, 2009
(86) PCT No.: PCT/EP2009/052180

§ 371 Date: Nov. 16, 2010

(30) Foreign Application Priority Data
Mar. 3, 2008 (DE) 10 2008 012 355.2

(51) Int. Cl. H04B 10/10

(52) U.S. Cl. 398/140

(57) ABSTRACT

The invention relates to a control unit comprising a data transmission device, comprising at least one module (6) which is arranged on a mounting plate (1) and actively connected to a power supply system. The data are as least forwarded to a second module (7) which is arranged on a second mounting plate (2). Data transmission from the first module (6) to the at least one additional module (7) proceeds via an optical transmission device (4).

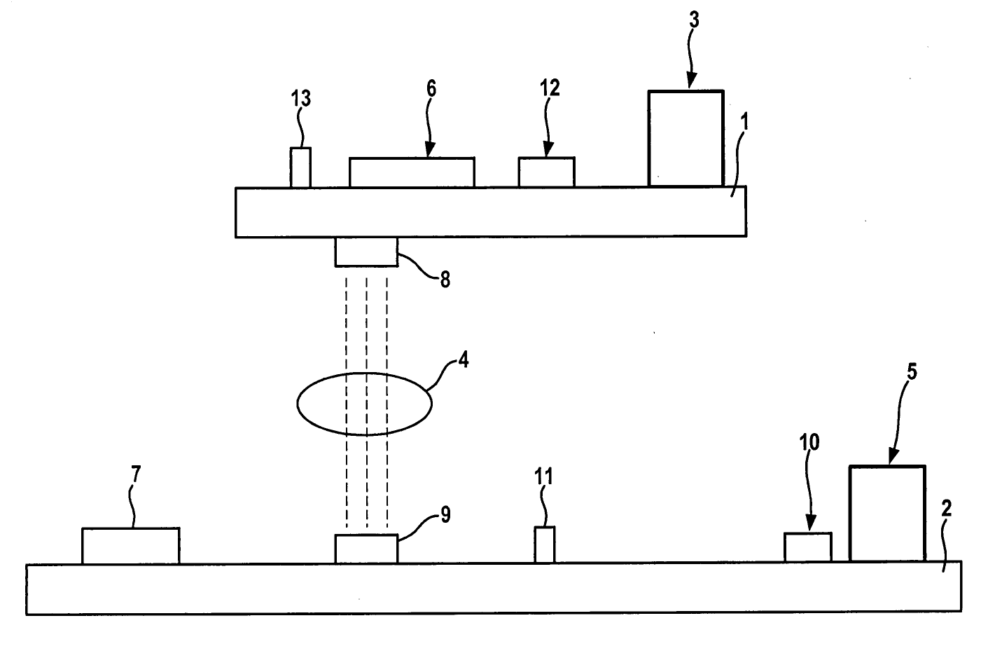

### FIELD OF THE INVENTION

The present invention relates to a control unit including a data transmission device, having at least one module situated on a mounting plate and being operatively connected to a voltage supply

### BACKGROUND INFORMATION

In connection technology, data are transmitted between modules on different printed circuit boards via metallic connections. Typically, one connection is used per signal. This results in high costs for final assembly. Moreover, metallic connections are exposed to severe stresses when vibrations occur on the control unit and are consequently easily interference-prone. Furthermore, when metallic connections are used, the transmission speed between the individual modules is limited and they are furthermore very susceptible to electromagnetic couplings and the malfunctions associated with them.

### SUMMARY OF THE INVENTION

The exemplary embodiments and/or exemplary methods of the present invention provides that the data are transmitted from one module to at least one additional module via an optical transmission device. As a result, information is no longer transmitted between individual modules within a control unit via interference-prone metallic connections.

It is also advantageous that a module is designed as an integrated expansion module (IEM), which is supplied with power via a plug connection connected to the mounting plate. The individual modules may be exchanged as, desired, as it is not necessary for the pin number of the module to be limited. The control unit may be designed to be more flexible without significant additional costs, as the modules may be replaced by other modules without additional changes on the mounting plate. Power may be supplied to the individual modules in a very simple manner through the plug connection. The optical transmission connection makes it possible, for example, to exchange the module on the first mounting plate without difficulty and replace it with another module. If the pin number of the module situated on the first mounting plate is changed, the optical connection makes it unnecessary to make a change on the second mounting plate. Due to the optical connection, additional functions of the module situated on the first mounting plate or printed circuit board do not require changes on the optical transmission device. As already mentioned, compared to metallic connections, any amount of information may be forwarded. As a result, the construction and assembly costs of the control unit may be reduced.

According to a refinement of the exemplary embodiments and/or exemplary methods of the present invention, an additional possibility is that the module situated on the first mounting plate is operatively connected to the module situated on the second mounting plate for data transmission via the optical transmission device. This is a decisive advantage compared to the present-day control units.

It is furthermore advantageous that the first module or the integrated expansion module or IEM is operatively connected via the optical transmission device to one or a plurality of modules situated on the second mounting plate, which are supplied with power at least via one plug connection connected to the second mounting plate. Due to the optical transmission device, the mounting plates according to the exemplary embodiments and/or exemplary methods of the present invention and the modules used may also be easily installed in a very small space and under difficult installation conditions.

To this end, it is also advantageous that the data are transmitted in the one direction with the aid of the first optical device and the data are transmitted in the other or opposite direction with the aid of a second optical device. In this manner, the information may be exchanged unhindered in both directions at any time.

According to a specific embodiment of an object according to the exemplary embodiments and/or exemplary methods of the present invention, it is finally provided that the optical transmission device includes a transmitter provided on the first mounting plate and a receiver situated diametrically opposed on the second mounting plate.

It is of particular significance for the exemplary embodiments and/or exemplary methods of the present invention that the optical transmission device is designed as a laser or infrared device.

The exemplary embodiments and/or exemplary methods of the present invention is explained in greater detail below with reference to the drawing.

### BRIEF DESCRIPTION OF THE DRAWING

The FIGURE shows a wireless connection between a first mounting plate (IEM) and a second mounting plate, also referred to as a printed circuit board.

### DETAILED DESCRIPTION

The drawing shows that a first mounting plate 1 and a second mounting plate 2, also referred to below as a printed circuit board, are operatively connected via an optical transmission device 4 instead of a metallic connection, and the information or data transfer takes place via this optical transmission device 4. Optical transmission device 4 may be designed as a laser or infrared device or the like and is therefore significantly more flexible and less susceptible to interferences than the metallic connections used to this date and is in particular insensitive to shocks occurring during operation. The optical transmission device described according to the present invention is able to transport data unidirectionally from the components of the first mounting plate (IEM) to the second mounting plate as well as exchange data starting from second mounting plate 2 to first mounting plate 1, depending on the purpose of the application. For the data transfer, optical transmission device 4 has a transmitter 8 on first printed circuit board 1 and a receiver 9 on second mounting plate or printed circuit board 2. For the provision of interference-free data transmission between the two mounting plates 1 and 2, it is important that optical transmission device 4 including its transmitter 8 is aligned diametrically opposed to receiver 9 situated on second mounting plate 2. Depending on the direction of the data transfer with respect to a one-dimensional data exchange or in the case of a bidirectional data exchange, the components transmitter 8 and receiver 9 must be situated on and aligned with the diametrically opposed plane surfaces of first mounting plate 1 (IEM) and second mounting plate 2 (printed circuit board).

Optical transmission device 4, described according to the present invention, for contactless data exchange between first mounting plate 1 and second mounting plate 2—as already mentioned above—may be manufactured cost-effectively and is not susceptible to occurring vibrations and other mechanical stresses. In contrast to metallic connections, optical transmission device 4 also offers unlimited transmission speed, and in contrast to metallic connections between the components accommodated on first mounting plate 1 and the components accommodated on second mounting plate 2, is not susceptible to interferences caused by electromagnetic coupling.

The transmission speed achievable using transmission device 4—described according to the exemplary embodiments and/or exemplary methods of the present invention—which provides the data exchange between first mounting plate 1 and second mounting plate 2, is dependent only on the optical transmission method used. However, electromagnetic interference sources do not influence the transmission performance between first mounting plate 1 and second mounting plate 2.

As also shown in the drawing, a first module 6, which may be designed as a controller, and additional electronic components such as chips 12 and 13 may be situated on first mounting plate 1 or the printed circuit board. A second module 7, which may also be designed as a controller, and additional electronic components such as, for example, chips 10 and 11, are situated on second mounting plate or printed circuit board 2.

First mounting plate 1 may be designed as an integrated expansion module (IEM) and supplied with power via a plug connection 3. Second module 7 situated on second mounting plate 2 or a main board is also supplied with power via a plug connection 5. Individual modules 6, 7 and plug connections 3, 5 may be screwed to mounting plates 1 and 2. Apart from screw connections, other assembly methods may be considered for first mounting plate 1 (IEM) or the second mounting plate (printed circuit board), which may be used in automated operation and for large numbers of pieces.

Power is supplied to the remaining modules, which may be situated on the upper sides or undersides of first and second mounting plates 1, 2, situated adjacent to one another, via plug connections 3 and 5 in conjunction with mounting plates 1 and 2, as represented in the drawing.

Apart from first optical transmission device 4, one or a plurality of transmission devices 4 may be provided between the two mounting plates 1, 2.

Data may be transmitted without interference in one direction using first optical transmission device 4 and data may be transmitted in the other or opposite direction using a second optical transmission device, providing the possibility of implementing bidirectional data transfer. The object described according to the present invention implements a wireless connection between the components of first mounting plate 1 and the components situated on second mounting plate 2 via an optical transmission device 4. Voltage is supplied to the first mounting plate via plug connection 3; however, a simple mechanical connection to second mounting plate 2 (printed circuit board) could continue to exist as an alternative to the voltage supply.

Except for the simple mechanical connection, the system described according to the present invention, as explained above, produces no mechanical connection via connecting cables between first mounting plate 1 and second mounting plate 2 if the voltage is supplied via plug connection 3. Should voltage be supplied alternatively by second mounting plate 2 via a simple mechanical connection, the mechanical stresses may be controlled very easily by the small number of connections (typically two).

Optical transmission device 4, together with transmitter 8 and receiver 9 which are used, is distinguished by a relatively high transmission speed in contrast to metallic connections and is only dependent on the optical transmission technology used. Furthermore, the object described according to the exemplary embodiments and/or exemplary methods of the present invention has the outstanding advantage that electromagnetic interference sources are entirely incapable of influencing the transmission performance on the connection path between first mounting plate 1 and second mounting plate 2.

1-7. (canceled)

8. A control unit, comprising:
a data transmission device, including:
at least one first module, situated on a mounting plate, which is operatively connected to a voltage supply;
an optical transmission device; and
at least one additional module situated on an additional mounting plate, wherein the at least one first module forwards data to the at least one additional module situated on the additional mounting plate, and wherein the data are transmitted from the at least one first module to the at least one additional module via the optical transmission device.

9. The control unit of claim 8, wherein the one module is one of an integrated expansion module and the IEM, which is supplied with power via a plug connection connected to the mounting plate.

10. The control unit of claim 8, wherein the module situated on the first mounting plate is operatively connected to the module situated on the second mounting plate via the optical transmission device for data transmission.

11. The control unit of claim 8, wherein one of the first module, the integrated expansion module, and the IEM is operatively connected via the optical transmission device to at least one module situated on the second mounting plate, which are supplied with power via at least one plug connection connected to the second mounting plate.

12. The control unit of claim 8, wherein the data are transmitted in the one direction with the aid of the first optical transmission device, and wherein the data are transmitted in the other or opposite direction with the aid of a second optical transmission device.

13. The control unit of claim 8, wherein the optical transmission device includes a transmitter provided on the first mounting plate and a diametrically opposed receiver situated on the second mounting plate.

14. The control unit of claim 8, wherein the optical transmission device includes one of a laser and an infrared device.
